(19) United States
(12) Patent Application Publication
(10) Pub. No.: US 2009/0152437 A1
(43) Pub. Date: Jun. 18, 2009

(54) MOTOR CHASSIS ADAPTER ASSEMBLY

(76) Inventor: Paul Romanick, Cumming, GA (US)

Correspondence Address: GEORGE R. REARDON, 3356 STATION COURT, LAWRENCVILLE, GA, 30044, US

(21) Appl. No.: 12/334,424

(22) Filed: Dec. 12, 2008

Related U.S. Application Data
(60) Provisional application No. 61/013,252, filed on Dec. 12, 2007.

(51) Int. Cl. F16M 1/04; F16M 9/00

(52) U.S. Cl. 248/672; 248/681

(57) ABSTRACT

The technology described herein provides a motor chassis adapter assembly for use on existing equipment and for use on newly manufactured equipment to divide heavy upright machines into lighter, more manageable components. The motor chassis adapter assembly includes a second interlocking adapter plate configured for affixation to a motor. The second interlocking adapter plate is configured to interlock with the first interlocking adapter plate. The first and second interlocking adapter plates can be shaped in the general form of a planar ring. The first and second interlocking adapter plates are interlocked by placement of one plate into the other and by subsequent rotation. Male and female slots are disposed upon the interlocking adapter plates for interlocking. The assembly includes a locking pin to secure the interlocking adapter plates prevent disengagement. A removable motor is provided. An upright machine having a removable motor for lift and transport is provided.

### CROSS-REFERENCE TO RELATED APPLICATION(S)

The present non-provisional patent application claims the benefit of priority of U.S. Provisional Patent Application No. 61/013,252, which is entitled “TWO PART FLOOR BUFFER”, which was filed on Dec. 12, 2007, and which is incorporated in full by reference herein.

### FIELD OF THE INVENTION

The technology described herein relates generally to heavy, user-operated upright machines such as floor buffers, core drillers, and the like, having a vertically mounted motor. More specifically, this technology relates to interlocking adapter plates for use between a removable motor and the chassis of the upright machine.

### BACKGROUND OF THE INVENTION

Many upright machines, such as floor buffers, core drillers, industrial maintenance machines, and the like, are known in the art. Such machines are easily user-operated when in use for the intended purpose of the machine (i.e., buffing a floor surface, core drilling into concrete, etc.). In operation the bulk of the weight of the upright machine is supported on a floor or ground surface underneath. However, for an operator to lift and transport such an upright machine proves difficult, if not impossible, and unsafe due to the excessive weight of the upright machine.

Related patents known in the art include the following: U.S. Pat. No. 1,847,323, issued to Yutzler et al. on Mar. 1, 1932, discloses a floor machine. U.S. Pat. No. 2,026,006, issued to Wennerstrom on Dec. 31, 1935, discloses a surface treating machine. U.S. Pat. No. 3,428,984, issued to Collier on Feb. 25, 1969, discloses an adjustment mechanism for industrial maintenance machines.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a motor chassis adapter assembly for use on existing equipment and for use on newly manufactured equipment to divide heavy upright machines into two lighter, more manageable components.

In one exemplary embodiment, the technology described herein provides a motor chassis adapter assembly. The motor chassis adapter assembly includes a first interlocking adapter plate configured for affixation to a chassis. The motor chassis adapter assembly includes a second interlocking adapter plate configured for affixation to a motor. The second interlocking adapter plate is configured to interlock with the first interlocking adapter plate. The first and second interlocking adapter plates can be shaped in the general form of a planar ring. The first and second interlocking adapter plates are interlocked by placement of one plate into the other and by a subsequent rotation.

The motor chassis adapter assembly also can include at least two male slots disposed upon the first interlocking adapter plate and at least two female slots disposed upon the second interlocking adapter plate that are configured to receive the two male slots disposed upon the first interlocking adapter plate, thereby interlocking the first and second interlocking adapter plates.

Alternatively, the motor chassis adapter assembly can also include at least two male slots disposed upon the second interlocking adapter plate and at least two female slots disposed upon the first interlocking adapter plate that are configured to receive the two male slots disposed upon the first interlocking adapter plate, thereby interlocking the first and second interlocking adapter plates.

The motor chassis adapter assembly also can include a locking pin. The locking pin is configured to secure and maintain the first and second interlocking adapter plates once interlocked and to prevent disengagement. The locking pin can be a spring-loaded locking pin.

The motor chassis adapter assembly also can include multiple apertures disposed on an outer rim of each of the first and second interlocking adapter plates. Each aperture on the first interlocking adapter plate is configured to receive a bolt with which to secure the first interlocking adapter plate to a chassis. Each aperture on the second interlocking adapter plate is configured to receive a bolt with which to secure the second interlocking adapter plate to a motor.

In operation, the first interlocking adapter plate and the second interlocking adapter plate are configured for selective interlock when in use to secure a motor to a chassis and selective unlock for separation, lift, and transport.

The first interlocking adapter plate can be machined to an existing chassis. The second interlocking adapter plate can be machined to an existing motor.

In another exemplary embodiment, the technology described herein provides a removable motor, having a motor chassis adapter assembly, for operative use upon a chassis of an upright machine. The removable motor assembly includes a motor for use on an upright machine, a first interlocking adapter plate configured for affixation to a chassis of the upright machine, a second interlocking adapter plate affixed to an underside of the motor and configured to interlock with the first interlocking adapter plate. The motor operatively is separated and removed from the chassis by an operator for lift and transport. The motor, having a motor chassis adapter assembly, is configured for use on a plurality of varied upright machines.

The first interlocking adapter plate and the second interlocking adapter plate affixed to the underside of the motor are interlocked by placement of the second interlocking adapter plate into the first interlocking adapter plate and a clockwise rotation.

The motor further includes a lift handle such that when the second interlocking adapter plate affixed to the underside of the motor is rotated out of the first interlocking adapter plate by rotation of the motor the motor is configured for lift by the handle and removal from the chassis of the upright machine.

In yet another exemplary embodiment, the technology described herein provides an upright machine having a removable motor for lift and transport. The upright machine includes an upright machine having a chassis, a removable motor vertically mounted upon the chassis, the chassis and motor proximate to a floor surface, a first interlocking adapter plate, the first interlocking adapter plate affixed to the chassis of the upright machine, and a second interlocking adapter plate affixed to an underside of the motor, the second interlocking adapter plate configured to interlock with the first interlocking adapter plate on the chassis. The motor operatively is separated and removed from the chassis by an operator for lift and transport. The upright machine can be a floor treatment machine. The upright machine can be a core driller.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front perspective view of a motor chassis adapter assembly in use on an upright machine, according to an embodiment of the technology described herein;

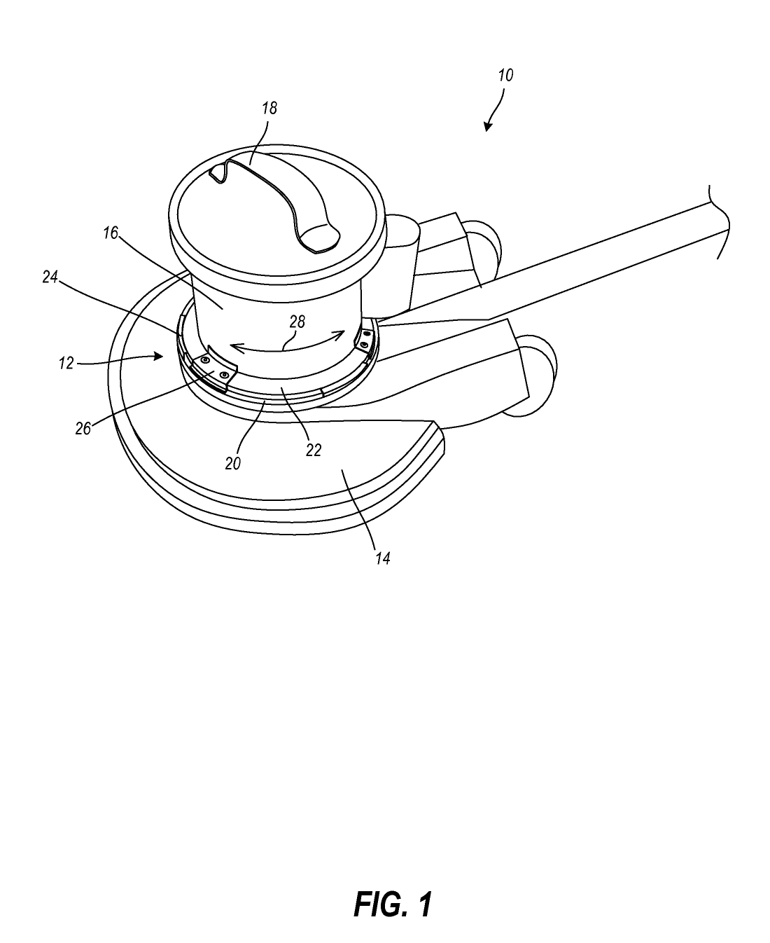

FIG. 2 is an expanded front perspective view of the motor chassis adapter assembly in use on an upright machine as depicted in FIG. 1, illustrating, in particular, the removal or placement of the removable motor;

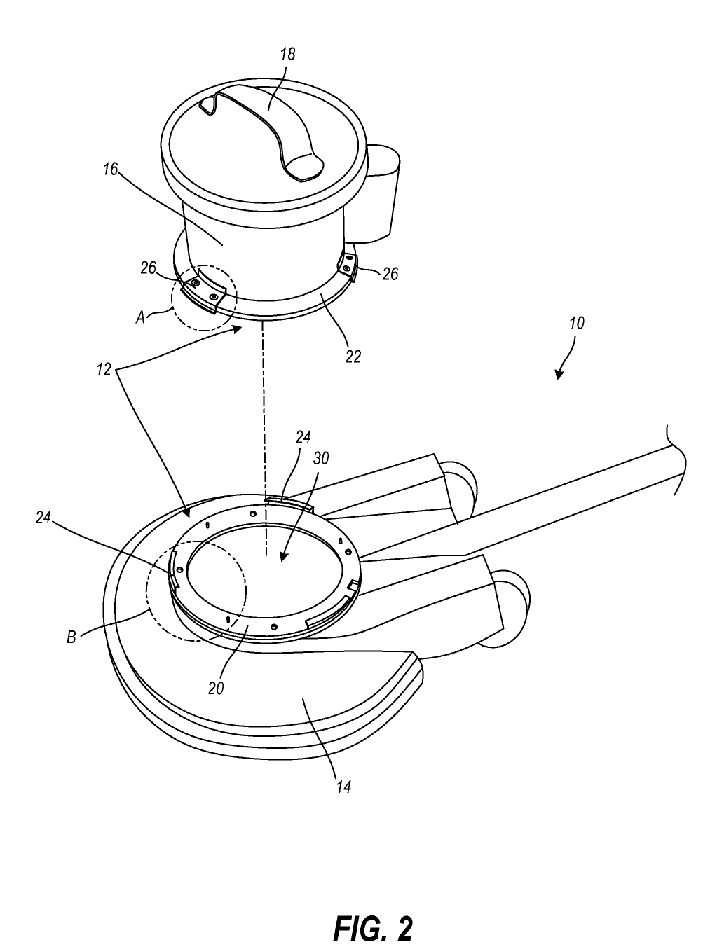

FIG. 3 is a close-up front perspective view of a potion of the motor interlocking adapter plate and a male slot, according to an embodiment of the technology described herein;

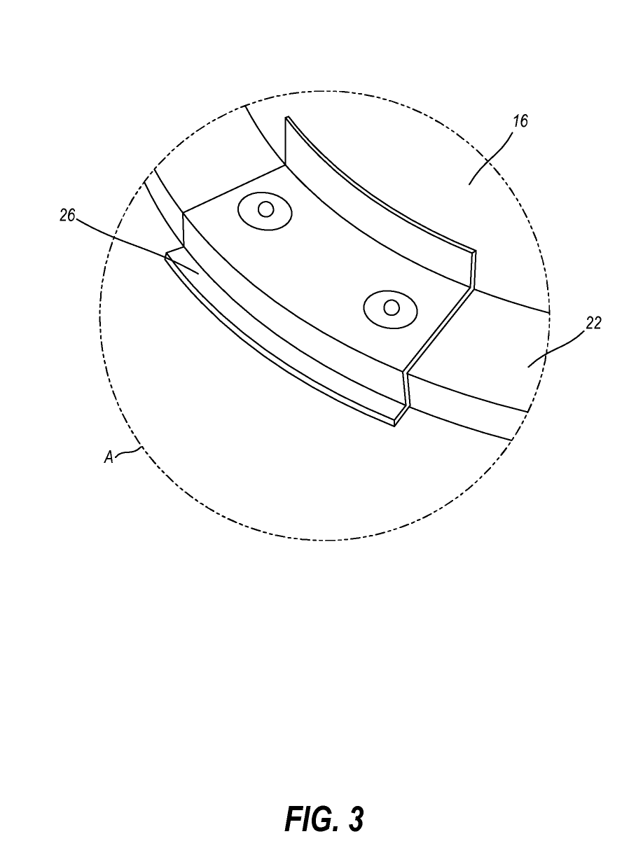

FIG. 4 is a close-up front perspective view of a potion of the chassis interlocking adapter plate and a female slot, according to an embodiment of the technology described herein;

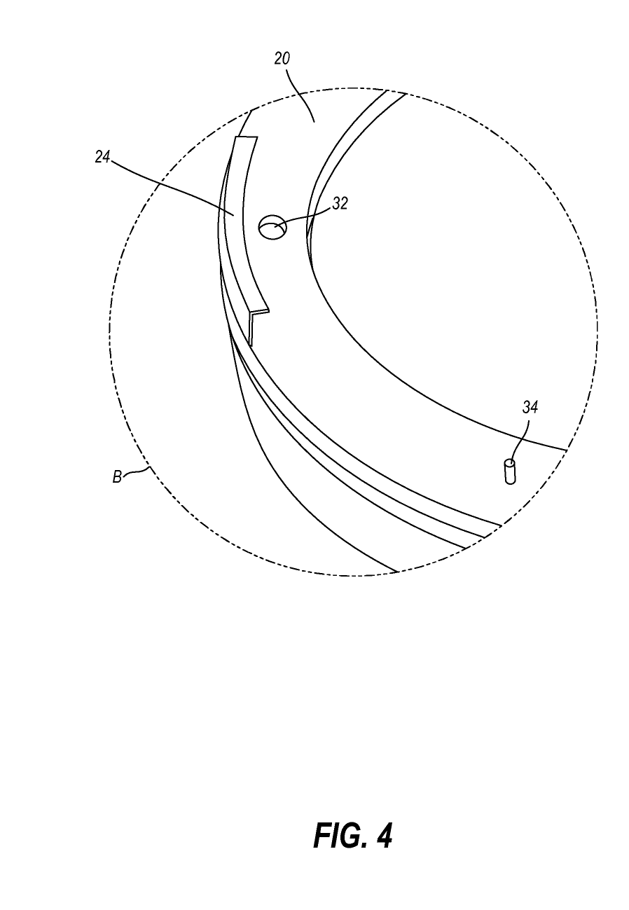

FIG. 5 is a front perspective view of a chassis interlocking adapter plate, according to an embodiment of the technology described herein;

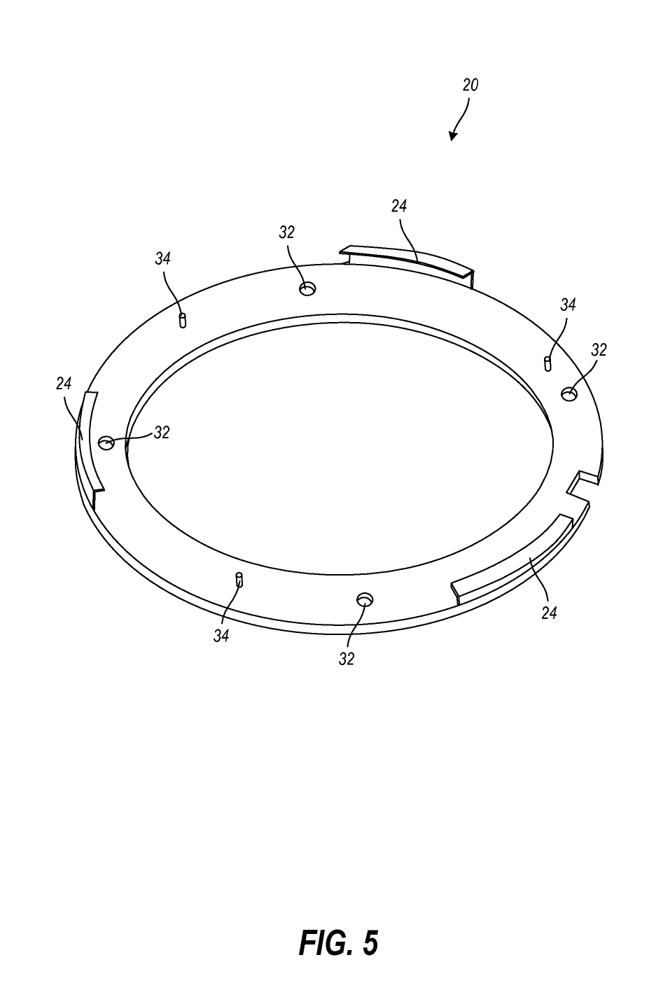

FIG. 6 is a front perspective view of a motor interlocking adapter plate and motor it is attached to, according to an embodiment of the technology described herein; and

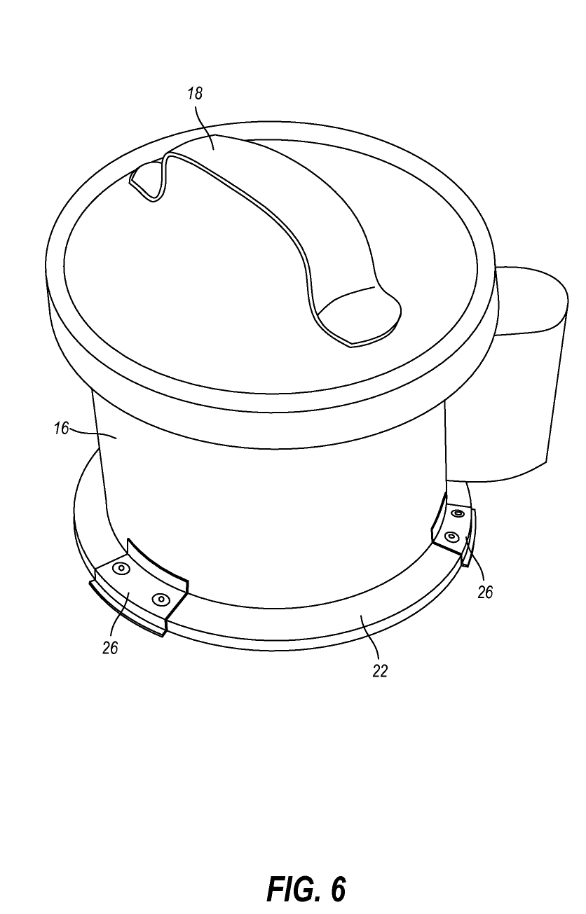

FIG. 7 is a bottom perspective view of a motor interlocking adapter plate and motor it is attached to, according to an embodiment of the technology described herein.

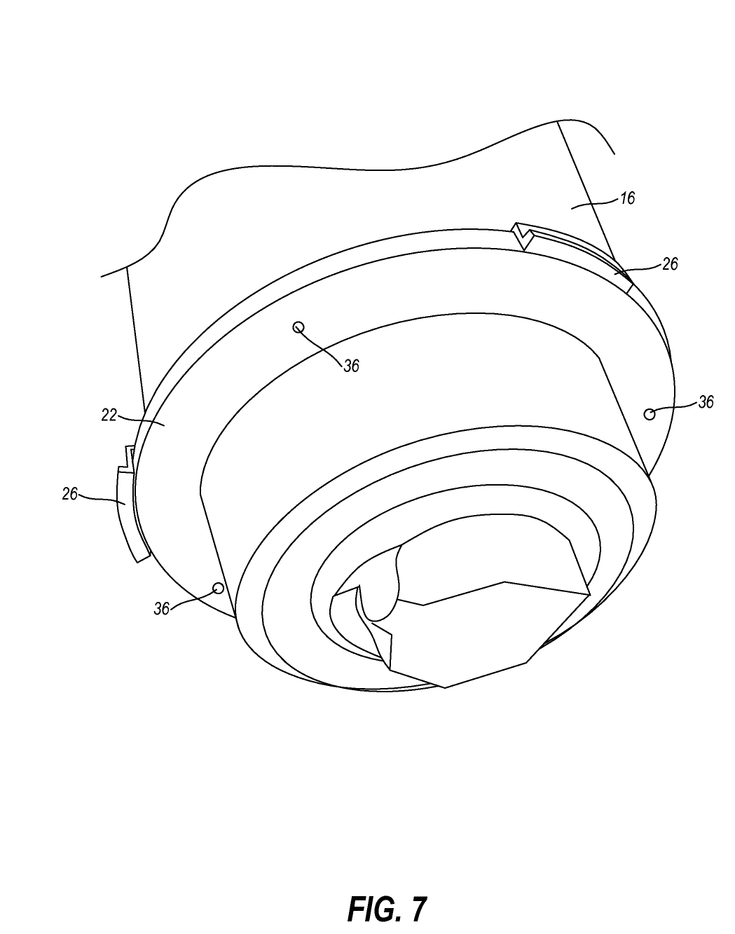

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a motor chassis adapter assembly for use on existing equipment and for use on newly manufactured equipment to divide heavy upright machines into two lighter, more manageable components.

Referring now to the Figures, a motor chassis adapter assembly 12 in use on an upright machine 10 is shown. As shown, the upright machine 10 is a floor buffer machine; however, the motor chassis adapter assembly 12 is configured for use in other upright machines such as, but not limited to, concrete core drillers, rotating brushes and sweepers, and the like.

An upright machine 10, like the one shown, is generally configured with a chassis 14 that is relatively close to a ground or floor surface, such as in a floor buffer or a concrete core driller. Upon the chassis 14 a motor 16 is mounted. The motor 16 can be vertically mounted. The motor 16 depicted in the Figures is electric, but other non-electric motors and/or small engines can be utilized with the motor chassis adapter assembly 12. The motor 16 can be used to spin a buffer, brush, drill, blade, etc. on the underside of the chassis 14. The upright machine 10 is operable by a user who grasps the machine arm and handle and machine controls (not shown) on the frame that attaches to the chassis 14. An upright machine 10 is generally operable by a single user while in use for its intended function (buffing a floor, drilling a core into concrete, etc.), but, as a single, inseparable unit is often difficult, if not impossible, to lift and transport without a risk of injury due to the excessive weight of the machine.

The motor chassis adapter assembly 12 is assembled from two interlocking adapter plates 20, 22. The interlocking adapter plates 20, 22 can be manufactured from a strong metal or similar material to ensure safe and secure interconnectivity of the motor 16 to the chassis 14. The chassis interlocking adapter plate 20 and the motor interlocking adapter plate 22, as shown, are shaped in the general form of a planar ring. A chassis interlocking adapter plate 20 is configured for affixation to the chassis 14. A motor interlocking adapter plate 22 is configured for affixation to the motor 16.

The motor interlocking adapter plate 22 is configured to interlock with the chassis interlocking adapter plate 20. Use of the motor chassis adapter assembly 12 in this manner enables separation of the motor 16 from the chassis 14 of the upright machine 10, thus creating two, lighter components that are more manageable by a single operator. Thus, a much lighter and safer upright machine 10 is provided, by incorporation of the motor chassis adapter assembly 12.

A handle 18 is provided on the vertically mounted motor 16 to aid with lifting in both removing and installing the motor 16 on the chassis 14. The handle 18 can be disposed upon a top surface of the motor 16. The handle 18 is also useful in holding the motor 16 while aligning the motor interlocking adapter plate 22 with the chassis interlocking adapter plate 20 and while rotating the motor 16 clockwise to interlock with the chassis 14 and counter-clockwise to disengage from the chassis 14.

The motor interlocking adapter plate 22 further includes a plurality of male slots 26 disposed upon an outer rim. The chassis interlocking adapter plate 20 further includes a plurality of female slots 24 disposed upon an outer rim. The male slots 26 and the female slots 24 are configured to intersect with each other. The male slots 26 and the female slots 24 are matched in pairs for alignment and are configured to interlock the motor interlocking adapter plate 22 to the chassis interlocking adapter plate 20.

The male slots 26 can be affixed to the motor interlocking adapter plate 22 and the female slots 24 can be affixed to the chassis interlocking adapter plate 20 by utilizing bolts, by welding, or by another secure means. Additionally, the male slots 26 can be integrally formed with the motor interlocking adapter plate 22 and the female slots 24 can be integrally formed with the chassis interlocking adapter plate 20. As depicted in the figures, three male slots 26 and three female slots 24 are shown; however, it will be apparent to those in the art that fewer or greater numbers can be utilized.

The motor interlocking adapter plate 22 can be attached to the motor 16 in a variety of ways. Likewise, the chassis interlocking adapter plate 20 can be attached to the chassis 14 is a variety of ways. As depicted in the Figures, apertures 32 are provided through which bolts can be utilized to secure the motor interlocking adapter plate 22 to the motor 16 and the chassis interlocking adapter plate 20 to the chassis 14. As will be apparent to one of ordinary skill in the art, alternative means can be utilized to secure the plates. For example, welding, adhesion, etc. can be utilized. Additionally, the interlocking adapter plates 20, 22 can be integrally formed with the motor 16 and the chassis 16, respectively.

These disclosed configurations provide for interlocking adapter plates 20, 22 that can be integrally formed with a motor 16 and chassis 14 at time of original manufacture and/or assembly, and for interlocking adapter plates 20, 22 that can be retrofitted onto existing equipment. This also provides for a removable motor 16 and motor interlocking adapter plate 22 that can interchanged on a variety of upright machines 10 configured with a corresponding chassis interlocking adapter plate 20.

The motor chassis adapter assembly 12 further provides for the use of one or more locking pin 34. The locking pin 34 is used to secure the motor interlocking adapter plate 22 and chassis interlocking adapter plate 20 one to another once rotated into place and interlocked. A locking pin 34 can be received into a pin hole 36. A locking pin 34 can be a spring-loaded locking pin.

In operation, a motor 16 that currently is unattached to the chassis 14 is grasped from the handle 18 by an operator. The motor 16 is lifted and hovered over the chassis 14, particularly over opening 30 wherein motor components will be lowered to an underside of the chassis to be attached with a buffer, brush, drill, or the like. Once the motor interlocking adapter plate 22 on the motor 16 is seated within the chassis interlocking adapter plate 20 on the chassis 14, the handle 18 is turned to rotate (as shown by direction arrow 28) the motor 16 and the attached motor interlocking adapter plate 22 to interlock with the chassis interlocking adapter plate 20.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A motor chassis adapter assembly comprising:
a first interlocking adapter plate, the first interlocking adapter plate configured for affixation to a chassis; and
a second interlocking adapter plate, second interlocking adapter plate configured for affixation to a motor, the second interlocking adapter plate configured to interlock with the first interlocking adapter plate.

2. The motor chassis adapter assembly of claim 1, wherein the first interlocking adapter plate and the second interlocking adapter plate are shaped in the general form of a planar ring.

3. The motor chassis adapter assembly of claim 1, wherein the first interlocking adapter plate and the second interlocking adapter plate are interlocked by placement of one plate into the other and by a subsequent rotation.

4. The motor chassis adapter assembly of claim 1, further comprising:
at least two male slots disposed upon the first interlocking adapter plate; and
at least two female slots disposed upon the second interlocking adapter plate and configured to receive the two male slots disposed upon the first interlocking adapter plate, thereby interlocking the first and second interlocking adapter plates.

5. The motor chassis adapter assembly of claim 1, further comprising:
at least two male slots disposed upon the second interlocking adapter plate; and
at least two female slots disposed upon the first interlocking adapter plate and configured to receive the two male slots disposed upon the first interlocking adapter plate, thereby interlocking the first and second interlocking adapter plates.

6. The motor chassis adapter assembly of claim 1, further comprising:
a locking pin, the locking pin configured to secure and maintain the first and second interlocking adapter plates once interlocked and to prevent disengagement.

7. The motor chassis adapter assembly of claim 6, wherein the locking pin is a spring-loaded locking pin.

8. The motor chassis adapter assembly of claim 1, further comprising:
a first plurality of vertical apertures disposed on an outer rim of the first interlocking adapter plate and each aperture configured to receive one of a first plurality of bolts with which to secure the first interlocking adapter plate to a chassis; and
a second plurality of vertical apertures disposed on an outer rim of the second interlocking adapter plate and each aperture configured to receive one of a second plurality of bolts with which to secure the second interlocking adapter plate to a motor.

9. The motor chassis adapter assembly of claim 1, wherein the first interlocking adapter plate and the second interlocking adapter plate are configured for selective interlock when in use to secure a motor to a chassis and selective unlock for separation, lift, and transport.

10. The motor chassis adapter assembly of claim 1, wherein the first interlocking adapter plate is configured to be machined to an existing chassis; and wherein the second interlocking adapter plate is configured to be machined to an existing motor.

11. A removable motor assembly, having a motor chassis adapter assembly, for operative use upon a chassis of an upright machine, the motor comprising:
a motor for use on an upright machine;
a first interlocking adapter plate, the first interlocking adapter plate configured for affixation to a chassis of the upright machine; and
a second interlocking adapter plate affixed to an underside of the motor, the second interlocking adapter plate configured to interlock with the first interlocking adapter plate;
wherein the motor operatively is separated and removed from the chassis by an operator for lift and transport.

12. The removable motor assembly of claim 11, wherein the motor, having a motor chassis adapter assembly, is configured for use on a plurality of varied upright machines.

13. The removable motor assembly of claim 11, wherein the first interlocking adapter plate and the second interlocking adapter plate affixed to the underside of the motor are interlocked by placement of the second interlocking adapter plate into the first interlocking adapter plate and a clockwise rotation.

14. The removable motor assembly of claim 11, wherein the motor further comprises a lift handle such that when the second interlocking adapter plate affixed to the underside of the motor is rotated out of the first interlocking adapter plate by rotation of the motor the motor is configured for lift by the handle and removal from the chassis of the upright machine.

15. An upright machine having a removable motor for lift and transport, the upright machine comprising:
an upright machine having a chassis;
a removable motor vertically mounted upon the chassis, the chassis and motor proximate to a floor surface;
a first interlocking adapter plate, the first interlocking adapter plate affixed to the chassis of the upright machine;
a second interlocking adapter plate affixed to an underside of the motor, the second interlocking adapter plate configured to interlock with the first interlocking adapter plate on the chassis;
wherein the motor operatively is separated and removed from the chassis by an operator for lift and transport.

16. The upright machine of claim 15, wherein the upright machine having a removable motor for lift and transport is a floor treatment machine.

17. The upright machine of claim 15, wherein the upright machine having a removable motor for lift and transport is a core driller.

18. The upright machine of claim 15, wherein the first interlocking adapter plate and the second interlocking adapter plate affixed to the underside of the motor are interlocked by placement of the second interlocking adapter plate into the first interlocking adapter plate and a clockwise rotation.

19. The upright machine of claim 15, further comprising:
at least two male slots disposed upon the first interlocking adapter plate;
at least two female slots disposed upon the second interlocking adapter plate and configured to receive the two male slots disposed upon the first interlocking adapter plate, thereby interlocking the first and second interlocking adapter plates; and
a locking pin, the locking pin configured to secure and maintain the first and second interlocking adapter plates once interlocked and to prevent disengagement.

20. The upright machine of claim 15, further comprising:
at least two male slots disposed upon the second interlocking adapter plate;
at least two female slots disposed upon the first interlocking adapter plate and configured to receive the two male slots disposed upon the first interlocking adapter plate, thereby interlocking the first and second interlocking adapter plates; and
a locking pin, the locking pin configured to secure and maintain the first and second interlocking adapter plates once interlocked and to prevent disengagement.
